(19) United States
(12) Patent Application Publication
(10) Pub. No.: US 2015/0274862 A1
(43) Pub. Date: Oct. 1, 2015

(54) METHOD FOR CONVERTING REACTIVE GROUPS OF SI-C-BOUND GROUPS OF SILANES WHILE SIMULTANEOUSLY INCREASING THE PHYSICAL DISTANCE BETWEEN SAID GROUPS

(71) Applicant: FRAUNHOFER-GESELLSCHAFT ZUR FÖRDERUNG DER ANGEWANDTEN FORSCHUNG E.V., München (DE)

(72) Inventors: Herbert Wolter, Tauberbischofsheim (DE); Somchith Nique, Eisingen (DE)

(73) Assignee: FRAUNHOFER-GESELLSCHAFT ZUR FORDERUNG DER ANGEWANDTEN FORSCHUNG E.V., Munchen (DE)

(21) Appl. No.: 14/434,630

(22) PCT Filed: Oct. 11, 2013
(86) PCT No.: PCT/EP2013/071302

§ 371 Date: Apr. 9, 2015

(30) Foreign Application Priority Data
Oct. 11, 2012 (DE) 10 2012 109 685.6

(51) Int. Cl. C08F 130/08; C07F 7/18; C08F 275/00

(52) U.S. Cl. CPC C08F 130/08; C08F 275/00; C07F 7/1892

(57) ABSTRACT

The present invention relates to a method for converting reactive groups of Si—C bound groups of silanes or siloxanes while simultaneously increasing the physical distance between said groups, the Si—C bound groups having the grouping-AW(Z)a,
wherein
A represents a coupling group selected from —S—, —NH—and NR³, where R³ represents an unsubstituted or substituted hydrocarbon group or a (meth)acryl group,
W is a substituted or unsubstituted hydrocarbon group, the chain of which may be interrupted by one or more groups of —S—, —O—, —NH—, —NR ³—, —C(O)O—, —NHC(O)—, —C(O)NH—, —NHC(O)O—, —C(O)NHC(O)—, —NHC(O)NH—, —S(O)—, —C(S)O—, —C(S)NH—, —NHC(S)—, —NHC(S)O—, R³ having the aforementioned meaning, Z represents a functional group, which may be the same or different, selected from OH, the carboxylic acid group —COOH or a salt or an ester of said group, and a=2, 3, 4, 5 or a greater integer, characterized in that, in a single or second reaction, said groups of the silanes or siloxanes are either reacted with a compound (II)

Y—(W)ₖ-Q)_{b} (II)
where in Y is NCO, epoxy, or—if the groups Z are hydroxy groups—COA′, A′ representing a hydroxy, a halide, or —OC(O)R⁴, in which R⁴ is a substituted or unsubstituted hydrocarbon group,
W has the aforementioned meaning,
Q is either R¹ or OH, NR⁷₂, NR⁷₃⁺, CO₂H, SO₃H, PO(OH)₂, (O)PO(OH)₂, (O)PO(OR⁴)₂ or a salt or ester of the aforementioned acids, wherein R¹ is an unsaturated, organically polymerizable group, R⁴ has the aforementioned meaning, R⁷ has either the same meaning as R⁴ or two groups of R⁷ together may optionally represent an unsaturated alkylene group,
k=0 or 1, where k=0 only in the event that Y represents COA′, and
b=1, 2, 3, 4, or a greater integer;
or, in the event that Z═OH, the groups of the silanes or siloxanes are reacted with P₂O₅ or POCl₃.

The invention further relates to a method for producing silanes or siloxanes with the grouping -AW(Z)ₐ, and to multiple methods which have additional method steps on the basis of the aforementioned single or second reaction, the physical distance between the groups Q being increasable and the number thereof optionally being increasable. Furthermore, the invention relates to silanes and silicic acid(hetero)polycondensates which can be produced using said methods.

The present invention relates to a method for converting silicon-carbon-bound reactive groups of silanes or siloxanes containing at least two reactive groups per group. It is the object of the invention to increase the physical distance between these groups, and thereby potentially converting them into other reactive groups. In specific embodiments of the invention the method aims to introduce additional functional groups, optionally by incorporating branches. When individual steps of the method are repeated while introducing variable functionalities and chain branching, a variety of different, partly dendrimer-like compounds can be obtained having different organic crosslinking potential and chain length, different polarity, refractive index, and etching and complexation properties.

In the field of dental materials, but not limited thereto, it is important to be capable of providing a range of materials that may in principle be used for the same purposes and exhibit the same physical and mechanical properties, whereby these properties must be finely adjustable to specific, often even individual, requirements. Examples are the color and/or translucency of crowns, the hydrophilicity of the matrix, the shrinkage, the reactivity to substrates or other matrix or composite components such as dental tissue, co-reactants or reactants in ionomer composites where minimal changes often have a big impact. When the specialist, such as a dentist or a dental technician, working with these materials, is able to resort to a graduated range of materials required for his purposes, he is enabled to select the material that is an exact match for each application.

In the past 20 years, a variety of silanes have been developed that are not only hydrolytically condensable, but that can be subjected to additional organic polymerizations, for example, via reactive double bonds. By polymerization of existing double bonds and conversion of potential further reactive groups, a variety of condensates, polymers and composites can be generated from and/or with these silanes that are suitable for a variety of applications. Examples of such materials are disclosed in DE 40 11 044 A1, DE 44 16 857 C1, DE199 10 895 A1 and DE 196 27 198 A1. However, in these materials the physical distance of the different functional groups of the shines is still relatively small and they are located dose to the core of the molecule.

The object of the invention is to remedy this situation and to provide methods by which these functional groups, which are bound to silicon via a carbon-containing chain and a carbon atom of said chain, can be converted while simultaneously being moving into a position that increases the physical distance between these groups. Due to the structural arrangement of these chains and such movement, a plurality of different resins can be produced that are obtainable from silanes and silicic acid polycondensates (which may also be referred to as siloxanes or “ORMOCER®s”) having different organic crosslinking potential and conjugation length. In addition, various resins with variable functionalities are obtainable by transfunctionalization of the reactive groups. In a specific embodiment, it is preferred to thereby increase the number of present functional groups. A greater number of e,g. hydroxy or acid groups may advantageously enhance the hydrophilicity of the matrix or other properties of the condensates, polymers, and composites prepared from the silanes. Furthermore, when the branching reactions are performed repeatedly this simultaneously allows to generate dendrimer-like structures at the carbonaceous group.

To solve the object, the present invention proposes a method for converting reactive groups on Si—C— bound groups of silanes or siloxanes while simultaneously increasing the physical distance between these groups, with the Si—C bound groups having the grouping

-AW(Z)ₐ,

wherein

A represents a coupling group which is selected from —S—, —NH—and NR³, wherein R³ is (meth)acryl or a straight-chain, branched or cyclic, unsubstituted or substituted hydrocarbon group, e.g. alkyl, aryl, arylalkyl or alkylaryl, preferably an alkyl group with more preferably from one to six carbon atoms,

W is a straight-chained, branched or cyclic, substituted or unsubstituted hydrocarbon group, for example an alkylene, an arylene, an arylalkylene, or an alkylarylene or group, the chain of which may be interrupted by one or more groups of —S—, —O—, —NH³—, —C(O)O—, —NHC(O)—, —C(O)NH—, —NHC(O)O—, —C(O)NHC(O)—, —NHC(O)NH—, —S(O)—, —C(S)O—, —C(S)NH—, —NHC(S)—, —NHC(S)O—, where R³ has the aforementioned meaning,

Z represents a functional group which may be the same or different and is selected from OH, the carboxylic acid group —COOH or a salt or an ester of said group, and

a=2, 3, 4, 5 or a greater integer, wherein preferably a=2 or 3 and particularly preferably a=2, characterized in that said groups of the silane or siloxane are reacted, in a single or second reaction, either with a compound (II)

Y—(W)ₖ-(Q)_{b} (II)

wherein Y is NCO, epoxy, or—if the Z groups are hydroxy groups—COA′ where A′ is a hydroxy, halide or —OC(O)R⁴, and R⁴ is an unsubstituted or substituted hydrocarbon group, e.g., alkyl, aryl, arylalkyl or alkylaryl, and preferably an alkyl group having more preferably one to six carbon atoms,

W has the aforementioned meaning,

Q is either R¹ or OH, NR⁷₂, NR⁷₃⁺, CO₂H, SO₃H, PO(OH)₂, PO(OR⁴)₂, (O)PO(OH)₂, (O)PO(OR⁴)₂ or a salt of the aforementioned acids, where R¹ is an unsaturated, organically polymerizable group and R⁴ has the aforementioned meaning, R⁷ has either the same meaning as R⁴, or two R⁷ groups together may represent an optionally (hetero)substituted, optionally unsaturated, optionally aromatic hydrocarbon group, e.g., an alkylene group, with the proviso that Q, in the event b>1 in the compound (II), may have different meanings,

k=0 or 1, where k=0 only in the event that Y represents CON, and

b=1, 2, 3, 4, or a greater integer, preferably 1, 2 or 3,

or, in the event that Z=OH, the groups of silanes or siloxanes are reacted with P₂O₅ or POCl₃.

In the event that two R⁷ groups together represent a hetero-substituted aromatic hydrocarbon group, NR⁷₂ and NR⁷₃⁺ may, for example, be a pyridine group or the group of a cyclic ammonium compound or of a pyridinium derivative or the like. Q groups with the meaning NR⁷₂ or NR⁷₃⁺ may provide important additional functionalities in a resin prepared according to the invention. In this way, in the event Q is NR⁷₂, an activator molecule is generated which can be employed for redox-curing as mentioned above. Compounds and/or resins having NR⁷₃⁺ groups exhibit antimicrobial activity.

The invention thereby generally employs basic structures of the following formula (2):

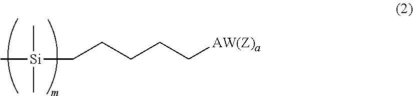

In this formula, the zigzag line represents the backbone of a hydrocarbon group bound to the silicium via a carbon atom, said backbone being optionally branched and arbitrary interrupted by hetero atoms or coupling groups or other hetero atom-containing groups, Examples are interruptions by —S—, —O—, —NH—, —O(O)O—, NHCH(O)—, —C(O)NH—, and the like. Since, for the purposes of the invention, the structure of the backbone group is not relevant, the expert can make an arbitrary selection in this respect. The hydrocarbon group does not contain functional groups, with the exception of the grouping AW(Z)ₐ, wherein the term “functional group” is meant to comprise in particular unsaturated, organically polymerisable groups, carboxylic acid or their metal salts or ester-containing groups (having the formula COOR⁰) with R⁰=unsubstituted or substituted hydrocarbon group or M^{x+}/_{1/x} where M^{x+} is hydrogen or an x-fold positively charged metal cation), groups of the formula —(O)_{b}P(O)(R*)₂ with b=0 or 1 and R*=unsubstituted or a substituted hydrocarbon group which is bound directly or via an oxygen bridge to the phosphorus atom, and comprises hydroxy groups. A, W, Z and a have the aforementioned meanings.

The three not further specified bonds of the Si atom represent, if the structure (2) is silane, additional silicon atom-bound groups. They may instead represent oxygen bridges to other silicon atoms and/or other metal atoms, if the structure (2) is a component of a silicic acid(hetero)polycondensate. (The term “(hetero)polycondensate” is understood as meaning that the condensate may comprise, in addition to silicon, other metal atom-co-condensed compounds, for example, B, Al, Ti, Zn and/or other transition metal atoms.) Since reactions of the present invention can be performed both on monomeric silanes as well as on silicic acid polycondensates that are already inorganically crosslinked the nature of said bond is not relevant. In the case of monomeric silanes, these groups may be, for example, groups that are hydrolyzable under hydrolysis conditions, such as those known to the expert, for example halides or alkoxides. Instead, one or more of these groups may be understood to mean OH. In other embodiments, at least one group of the bond symbolizes at least one Si—C-bound group, which may have any desired properties. These may differ from the aforementioned Si—C-bound group; alternatively, one or even two of said groups may have the meaning of this hydrocarbon group. The index in indicates that the structure in comprises silyl groups, and typically denotes 1 or 2, but may optionally also denote higher numbers such as 3, 4 or even larger. Frequently, m is 1. Theoretically, there is no upper limit restriction. If the structure comprises more than one silyl group, the second and optimal further silyl groups are located on the backbone of the structure, which, in this case must be accordingly branched.

In the present invention, in the context of an unsaturated organically polymerizable group, the attribute “polymerizable” and/or the corresponding noun “polymerization” is to be understood as meaning a polymerization reaction wherein the reactive double bond converts into a polymer under the influence of heat, light, ionizing radiation or by redox reaction (e.g. with an initiator (peroxide or the like) and an activator (amine or the like)). During this so-called addition polymerization or chain-growth polymerization cleavages of molecular components, movements, or rearrangements do not occur. Examples of unsaturated, organically polymerizable groups are therefore non-aromatic C═C double bonds, preferably double bonds such as those found in styryls or (meth)acryl acid derivatives that are accessible to Michael addition. Any unsaturated organically polymerizable group typically comprises at least two, and preferably up to about 50, optionally even more carbon atoms and may be bound directly or via a coupling group to the carbon skeleton of the hydrocarbon-containing group.

In the present invention, the term “(meth)acryl . . . ” is to be understood as meaning that it may represent the corresponding acrylic or the corresponding methacrylic compound, respectively.

The present (meth)acrylic acid derivatives include the acids themselves, optionally esters, amides, thioesters and the like in activated form.

In the reaction according to the invention, the silane or silicic acid polycondensate is reacted with the above-mentioned compound of formula (II) and/or in certain instances with P₂O₅ or POCl₃ in order to convert the reactive groups and simultaneously increase the physical distance between these groups.

By reaction with compound (II) according to the invention, a further group —(W)ₖ-(Q)_{b} is bound via a coupling group B to the fragment AW(Z)_{A} at the Si—C-bound group of the silane or silicilic acid polycondensate of the structure (2). The coupling group B is formed by Y attacking Z and can therefore be selected from ester, ether, acid amide and urethane groups.

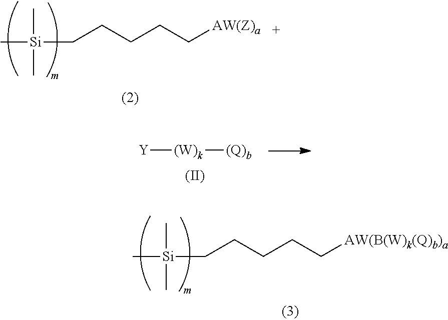

Since the compound (II) can comprise several as Q's, optionally independent of each other, the number of functional groups per Si—C-bound group may be increased and varied, and a dendrimer-like structure assembled.

In this reaction—and in all reactions described in the following—it is favorable for the compound of formula (II) to be employed in molar deficiency relative to the functional groups of the reactant, here the structure (2), i.e. when the molar ratio of the compound (II) to the functional groups Z bound to the groups Si—C is <1, and preferably is at most 0.95.

This technical teaching is based on the finding that the when compound (II) is employed in deficit, this compound is completely consumed, so that in materials in which the product of this reaction is used, monomers are no longer present that may pose possible complications from a toxicological or allergologic point of view. Moreover, it was found that it is not relevant for ali functionai groups to be fully converted, as a more or less large proportion of non-elongated Si—C bound groups in the mixture does not adversely affect the properties of the latter. And finally, there arises a significant advantage for possible additional reactions: the product of the reaction does not need to be washed or worked up in any other form, and can therefore be immediately subjected to a subsequent reaction in an uncomplicated manner, as is preferred in the present invention.

Preferably, for the single or second reaction of the invention, a compound (II) is used in which Q is R^{1.} This allows introduction of a C═C double bond-containing group into the Si—C-bound group via the linking group B at the positions Z, whereby the distance between the C═C double bonds is larger than the distance of the Z groups that were present previously.

In a further preferred embodiment that may be connected to, or independent of, the above embodiment, Z has the meaning of OH in the compound or condensate of structure (2) and is reacted with a compound (II) in which Y represents the isocyanate group. A urethane group is thereby generated as linkage group B.

The product of the reaction of the invention is thus a compound or a condensate with modified functional groups, further comprising at least one group Q located on a Si—C-bound hydrocarbon group, wherein, however, the group or groups Q, relative to the group Z in the structure (2), have a distance to the silicon atom, which is enlarged by B—W as a result of said reaction. The plurality of double bonds with relatively good movability over longer chains, being primarily located in the outer region of the silane and/or the siloxane, therefore having a relatively large physical distance from one another, may result, firstly, to reduced shrinkage during subsequent cross-linking, which can be of great advantage in particular in the dental field, and, secondly, to increased strength and reduced brittleness. in addition, the Si—C bound hydrocarbon group may optionally comprise additional functionalities in the event e.g. not all of the hydroxy groups of the structure represented by formula (2) are stoichiometrically converted (i.e., when the compound (II) is used in deficiency) and/or when a compound of formula (II) is used that comprises, in addition to an unsaturated organically polymerizable group, further functionalities independent thereof.

The aforementioned reaction will be explained in more detail below with reference to two examples:

First Example:

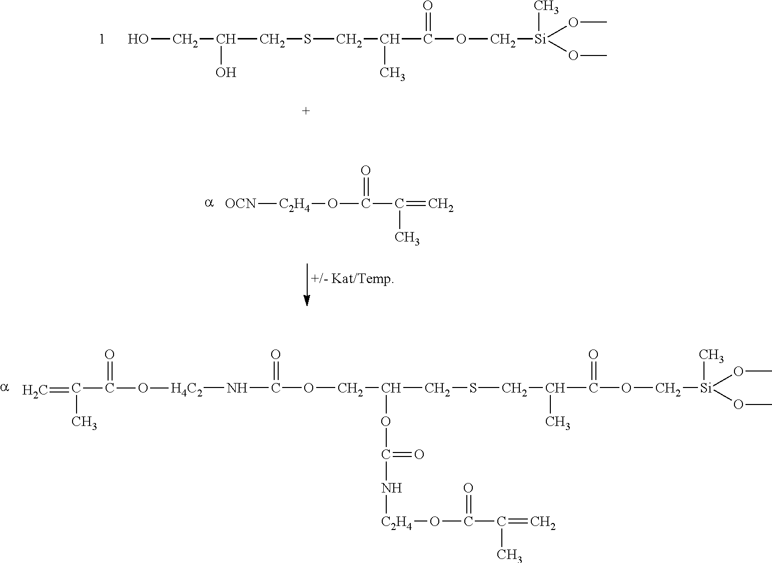

The two hydroxy groups (groups Z of structure (2)) serve as groups that are attacked in the isocyanate-methacrylate compound chosen as compound (II). As a result, a branched silyi methacrylate compound of structure (3) is generated in which, in comparison to the hydroxy groups in structure (2), the two methacrylate groups have moved to the outside around the H₄C₂—NH—C(O) group and thereby are arranged at a larger physical distance from one another. The product obtained in this reaction (3) has a very high strength with significantly reduced brittleness and significantly reduced hardness shrinkage.

In this example, as explained above, a deficiency of compound (II) can be used relative to the two hydroxy groups, so that both hydroxy groups of the starting material are not completely converted. Depending on the amount of compound (II) used, which can be up to 2 molar equivalents, a mixture is formed having either only partially converted secondary hydroxy groups or a branched Si—C-bound group having two methacrylate groups. This property allows for the generation of a finely graded range of products with strong but differently improved physical properties, such as fracture strength, modules of elasticity or deflection.

Second example of the reaction according to the invention. Instead of a structure having its Si—C-bound hydrocarbon group comprising a thioether group, a structure (2) can be employed, having for example a tertiary amino group comprising two hydroxy groups. Its reaction with the same isocyanate-methacrylate follows the following equation:

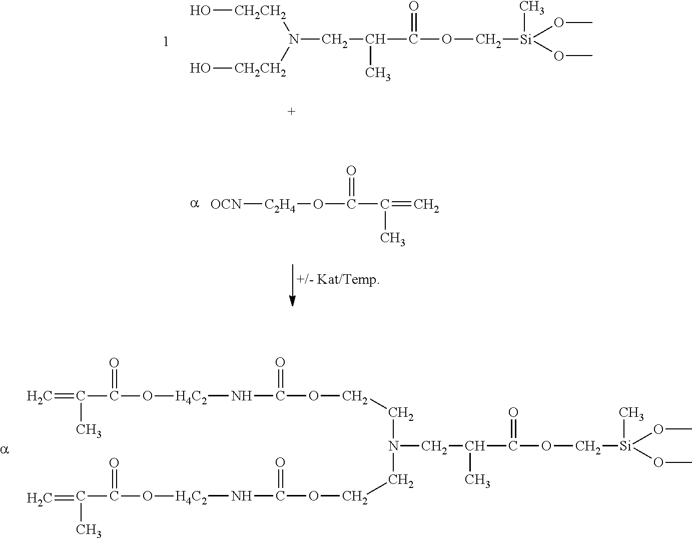

It is apparent that the C═C double bonds formed are arranged substantially further apart and are bound to substantially longer, flexible chains.

In terms of molar ratios, the same applies as described for the first example.

The products (3) of the two aforementioned examples of the reaction according to the invention comprise, as mentioned, organically polymerizable C═C double bonds, obtainable by converting hydroxy groups having a greater physical distance between the Si—C-bound groups compared to the distance between said hydroxy groups. This is one object of the present invention, They can be processed further in this form. In one variation of the invention that is described in more detail below they can, in turn, be converted to hydroxy functionalities having even greater physical distance between one another and may optionally serve to introduce C═C double bonds once again. This allows, among other features, to further increase the physical distances between the unsaturated organically polymerizable groups. In addition, in each of the above reactions the number of reactive groups can be increased, whereby dendrimer-like structures can be obtained. In a preferred variation of the invention certain functional groups are thereby introduced by further conversions. In a particularly preferred embodiment, the aforementioned possible conversions are performed using a hydrolyzed/condensed silane as starting material. As a result, starting from a single base resin and by introducing variable functionalities, a variety of resins with different organically crosslink potential and chain lengths can be produced having different polarity, refractive index, etching and complexation properties. Additional effects resulting from the binding of these functional groups, other than the dendrimerization and the antibacterial effect mentioned above, consist in that the complexing or adhesion properties of e.g. carboxylic acid, phosphonic acid or phosphoric acid groups are extremely improved due to the outward location of the respective groups (e.g. forming numerous effective “attack points”).

In a specific embodiment of the invention, the silanes or siloxanes having at least two hydroxy groups at the Si—C-bound groups are reacted with phosphorus pentoxide. Subsequent work-up with water (see Example 2) converts both hydroxy groups to phosphoric acid functionalities, which contains the remainder of the molecule as a mono-ester group enabling the product, for example, in aqueous solution, to be used as a dental adhesive:

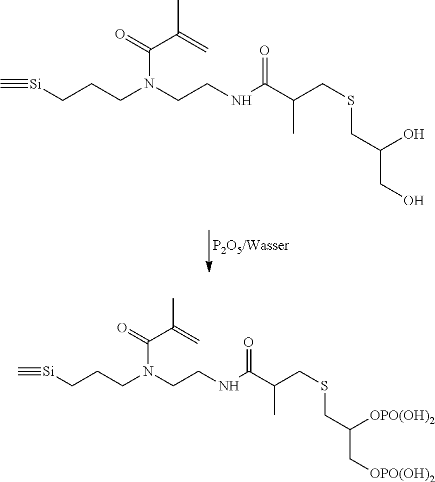

Of course, the products of this reaction do not contain a coupling group B and are therefore not included in the scheme of compounds (3).

As a matter of general principle, the functional groups contained in structure (3) and/or that are obtainable by reaction with phosphorus pentoxide may be employed for different purposes:
(1) The introduction of C═C double bonds located on the outside having an increased distance to one another results in reduced hardness shrinkage during crosslinking and very high strength accompanied by significantly reduced brittleness after curing.
(2) The introduction of aromatic groups enables an increase and/or adaptation of graded refractive index.
(3) structures having phosphoric acid ester groups represent a highly water-soluble product that can be used as a dental adheslve.
(4) It is possible to connect further compounds to the Si—C bound group via previously introduced organically polymerizable groups, in particular when said groups are reactive C═C double bonds. Firstly, this allows the introduction of variable functionalities into the system. Secondly, the physical distance between the corresponding functional groups can be further increased. Thirdly, by repeating once or several times a cycle of functionalization and linking, while simultaneously increasing the number of functional groups, dendrimer-like structures are obtainable.

In a preferred variation of the invention, compounds of structure (2) are prepared in a preceding, first reaction, as a rule starting from structures of the formula (1). i.e. silanes and silicic acid(hetero)polycondensates having at least one Si—C group group that comprises (a maximum) of one unsaturated, organically polymerizable group R¹. For the purpose of converting the unsaturated organically polymerizable group R¹ while simultaneously increasing the functionality, said groups are reacted with a compound of formula (I) as follows:

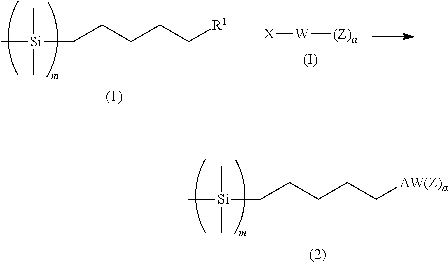

The index m and the group R¹ have the meanings indicated above. Simple examples of compounds of formula (1) are methacryloxyalkyltrialkoxysilanes as well as representatives of silanes and polycondensates of silanes (siloxanes), as disclosed in DE 40 11 044 A1, DE 44 16 857 C1, DE 196 27 198A1 or DE 199 10 895 A1.

In the compound of formula (I), X═SH, NH₂ or NHR⁴, and Z and W and the index a have the meaning as described for compound (2).

In this reaction, the group X of the compound (I) attacks the double bond of the group R¹: and thus extends the hydrocarbon group of the structure (1) by the fragment A-W via the coupling group A=-S—, —NH— or —NR⁴. The group Z, provided the reaction is performed stoiciometrically, is thereby a-fold introduced to the Si—C bound group.

In a preferred embodiment of said first reaction, X in the compound of formula (I) has the meaning of SH, In this variant, the group —W—(Z)ₐ of the compound of formula (I) is bound via thiolene addition to the unsaturated, organically polymerizable group R¹ bound to the Si—C-bound group. Alternatively, X may also represent NH₂ or, in a further alternative, NHR⁴, where R⁴ has the aforementioned meaning. These groups also attack the unsaturated C═C double bond, so that the group —W—(Z)ₐ is linked to the silicon atom-bound group via a NH—, or NR⁴⁻ bridge.

In a preferred embodiment independent thereof, which can be combined with each of the aforementioned embodiments, the group Z in the compound of formula (I) has the meaning OH or COOH. The meaning of Z═OH is particularly preferred, especially in combination with a=2 or 3, preferably a=2.

In the context of the present compound, the reaction of the silane or salicilic acid polycondensate having the structure (1) with the compound of formula (I) is referred to as “first reaction”. This is to be illustrated in more detail by a series of examples.

In the first of these examples, a silicic acid polycondensate of structure (1) is used as starting material that was prepared by hydrolysis and condensation of a (methacryloxymethyl)methylsilane (preferably via the “sol-gel” procedure) (see comparative example 1). This structure is then reacted with a compound of formula (I), wherein X represents a mercapto group, Z represents a hydroxy group, W represents a saturated hydrocarbon group having three carbon atoms and a=2:

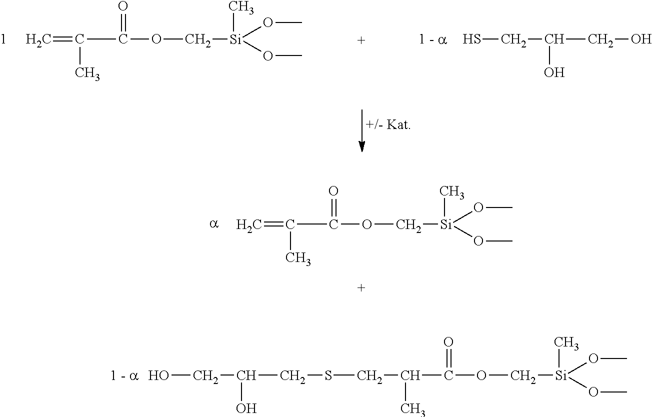

The product of this reaction (preparation examples 1a and 1b) contains a Si—C-bound hydrocarbon group extended by a sulfur atom and three carbon atoms in which the original functional group (the C═C double bond) is replaced by two hydroxy groups. It contains a thioether group as a linking group A.

Instead of the diol used in the example for the compound of formula (I), compounds having more than two hydroxy groups (3 or optionally 4 or more) may, of course, also be employed as compounds of formula (I). In that event, structures of the formula (2) are formed having a higher number of hydroxy groups, whereby in the subsequent reaction with the compound (II) a very high number of Q groups may be obtained if compounds (II) having two or more Q groups are employed.

Instead, mixed compounds, such as thioalcohols or aminoalcohols may also be employed.

If the first reaction is converted with a deficiency of compound (I), the product contains not only the structure of formula (2) but also unreacted material (of the structure (1)), see above example. Incompletely converted materials of this type may be employed in the present invention in all variants as required. In this event, a ratio of 0.5 to 0.95 mol of the reagent (the compound (I)) introducing the group Z is used; hence preferably 0.5 to 0.95 mol thioglycerol per mol of C═C double bond; alternatively, the compound of formula (I) may of course be used up to molar equivalence—as needed—or in some instances even above. As a rule, however, the latter is unfavorable in terms of the desirable avoidance of monomer groups being present in the resin.

In another variation of the invention, a compound of formula (I) is used for the first reaction in which the groups Z represent carboxylic acid groups (CO₂H). Mixed compounds are also possible, i.e., those compounds having both a hydroxy as well as acid functionality.

Instead of a compound of formula (I) in which X represents a mercapto group, it would also be possible to carry out this reaction with a compound of formula (I) in which X represents a primary or, less preferably, a secondary amino group, having two or more hydroxy groups or other Z groups as defined above.

As an example of such conversion, a second example of the first reaction shall serves to illustrate the generation of a silicilic acid polycondensate having a dihydroxy-substituted secondary amine:

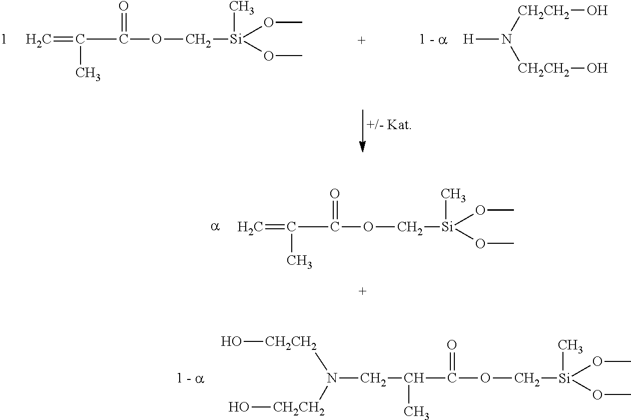

In this reaction, a may also represent not only 2, but instead 3 (or possibly 4 or above).

The difference to the previous example lies in the nature of the linkage group (in the present example, a tertiary amine rather than a thioether bridge). In terms of the modification of functional groups that is the focus of the invention, the choice of the X group is not relevant as it is merely responsible for the structure of the linkage group A between the newly bonded group —W—(Z)ₐ and the rest of the molecule, which—with a few exceptions—does not exert a technical function or effect. One of these exceptions pertains to the mercapto group, which, if used as group X, offers a specific advantage: the incorporation of the sulfur atom as the linking group A into the skeleton of Si—C-bound group causes an increase of the refractive index n_{D} of the silicilic acid polycondensate formed as compared to a secondary or tertiary amino group, which can be varied by the provision or omission of the thioether group. A second exception relates to basic protonateable amino groups.

Specific examples of compounds of formula (I) are: OH-functionalized thiols having two hydroxy groups such as thioglycerol, CO₂H-functionalized thiols having two carboxylic acid groups, such as mercaptosuccinic acid or 2-sulfanylmethyl succinic acid.

The first reaction does not necessarily have to be performed with previously hydrolytically condensed silanes, as illustrated above. Instead, the reaction may, of course, be performed using monomeric silanes.

In one embodiment of the invention, the product of the (first or only) reaction according to the invention may be the final product, namely in the event the group Q is R¹, i.e. an unsaturated organically polymerizable group, and also when Q is OH, NR⁷₂, NR₃⁺⁷, CO₂H, SO₃H, PO(OH)₂, PO(OR⁴)₂, (O)PO(OH)₂, (O)PO(OR⁴)₂ or a salt of the aforementioned acids.

In a second embodiment of the invention, the product of the reaction according to the invention is subjected to a third and possibly even further reaction(s), The third reaction can thereby be conducted in two variants:

In the first variant the Q group in the product (3) is an unsaturated organically polymerizable group (i.e., R¹). The reaction is analogous to the first reaction with a compound of formula (III),

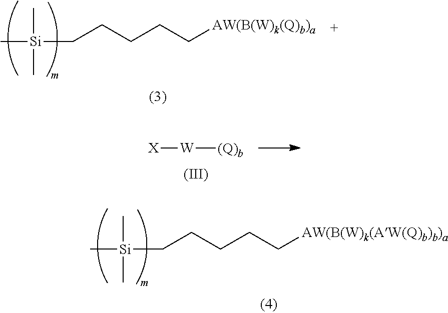

wherein X is as defined as for formula (I) and W, Q and b are as defined for formula (II) and A′ represents a coupling group that is formed as a result of an attack by the group Y of the molecule of the formula (III) at the C═C double bond of the organically polymerizable group R1. A product results in which the number of Q groups corresponds to a b b (as defined for the indices of the formulas (I) to (III) above); in other words, instead of each unsaturated polymerizable group R¹ that was initially present in the structure (1) a b b groups of Q are found in structure (4). If, for example, a dihydroxy compound was used as a compound of formula (I), as shown in the examples above, and mono acrylate (meth)acrylate as compounds (II) and (III) respectively, the product (4) contains two Q groups as functional groups in place of each originally unsaturated organically polymerizable group on a Si—C-bound group, that in addition are arranged at a much increased distance from one another. Accordingly, this number increases to four or eight in the event that the index b in the compound (II) and/or (III) is greater than 1, namely 2. The production of dendrimer-like structures is apparent. Furthermore, the groups R′ in form of the Q groups are also moved outwards by the grouping A-W—B—W-A-W in comparison to compound (1).

In the second variant of the third reaction, the Q group in the product (3) is selected from OH, the carboxylic acid group —COOH or a salt or an ester of said group, and the product (3) is reacted with a compound of the formula (II) in which the groups have the aforementioned meaning for said compound:

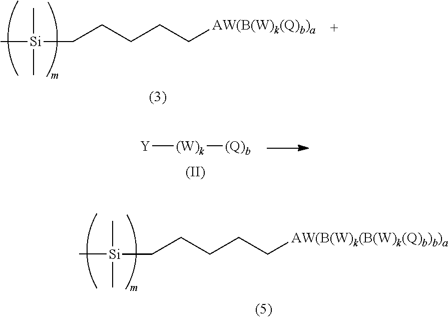

Structure (5) differs from structure (4) only in that the linkage group A is exchanged for B; in all other respects, the aforementioned applies. Otherwise, both structures (4) and (5) are comparable to structure (3), however with the number of Q groups with respect to (3) being greater by a factor of b (because of reaction with the compound (II) and/or (III)) and said groups being located further from the Si atom by a grouping A-W and/or B—W. Consequently, the effects are additionally increased in comparison to those described for (3). This applies particularly to the earlier-described reduction of shrinkage during subsequent cross-linking as well as to the material properties of strength and brittleness.

The third reaction, in turn, can be performed with a molar deficiency of compound (II) and/or compound (III), relative to the group Q in the structure (3), to obtain the structures (4) and/or or (5) in a mixture with structure (3). In this way, even more graduated products can be obtained.

In a variant of the invention, the products (4) and (5) are the end products.

The products (4) and (5) may—if therein is either an unsaturated organically polymerizable group R¹ or is selected from OH, the carboxylic acid group —COOH or a salt or an ester of said group—be optionally subjected to a fourth reaction; namely with a compound of formula (II) or of formula (III) depending on the meaning of group Q. The reactions are analogous to the two variants of the third reaction. As a result, this fourth reaction yields products that can be represented as follows:

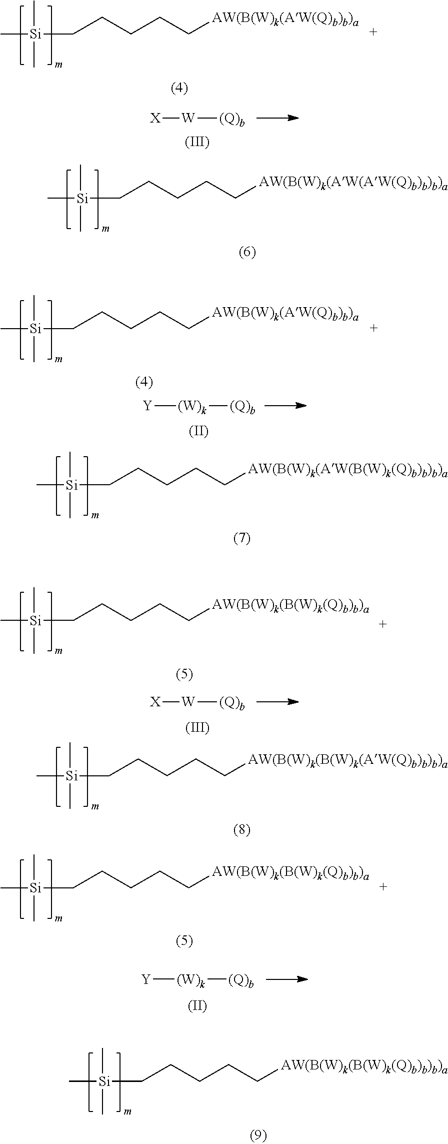

Both the starting products of these reactions as well as the respective end products can be traced back to the formula (3), whereby the b-fold group of the group of formula (3) was converted to a b-fold structure D. These products may therefore be represented by the following formula (A)

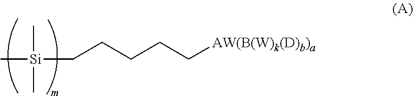

wherein D is selected from A′W(Q)_{b} (formula (4)), B(W)ₖ(Q)_{b} (formula (5)), A′W (A′W (Q)_{b})_{b} (formula (6)), A′W(B(W)ₖ(Q)_{b})_{b} (formula (7)), B(W)ₖ(A′W(Q)_{b})_{b} (formula (8)) and B(W)ₖB(W)ₖ(Q)_{b})_{b} (formula (9)).

In the aforementioned products resulting from reaction of (5) and (6) with (III) and/or (II), the Q groups are each present as a·b−b b-fold and with a further increased distance to the Si atom and increased physical distance to one another. In other respects, they differ—with the proviso that in each case similar groups Q and W groups are used—only by the number and distribution of he linkage groups A, A′ and B. The advantages of such dendrimers thus correspond to those described for product (3), but are amplified once more. An example of such a reaction is the reaction of a structure (4) where Z is at least partially OH, with an isocyanate-methacrylate.

The principle of the reaction sequence can be continued on this basis; since the products—at least in the event where X is SH or Y is NCO, and in particular if the compounds (I) to (III) are used in deficiency relative to the respective reactive functional groups—do not require isolation or purification structures can be produced in this manner having a finely tunable number of reactive groups and/or organically polymerizable groups Q on each Si—C-bound group, which are branched dendrimer-like.

In summary, the invention therefore enables—starting from silanes having organically polymerisable double bonds, e.g. C═C—containing silanes such as (methacryloxymethyl)-methyldimethoxysilan (see Examples; the hydrolytically condensed silicic acid polycondensates of said silane is designated as base resin system-1) by reaction with a compound (II) (eg. thioglycerol), and subsequent introduction of C═C groups (e.g. isocyanatoethyl methacrylate) and subsequent hydrolytic condensation according to the inventive method to obtain a silicic acid polycondensate the groups Q of which, e.g. OH, CO₂H and/or C═C, may be optionally further functionalized. The hydrolytic condensation may naturally already be performed at an earlier stage, for example, at the level of the starting material (see base resin system-1) or at the level of the silane containing at least two groups Z. If such product is already available, the first step of this reaction sequence does not need to be performed.

It is thereby preferred to start from a hydrolyzed/condensed silane (e.g. the base resin system I, see Examples) and/or to optionally hydrolytically condense the corresponding starting silane optionally in combination with other silanes or other hydrolyzable components such as alkoxides of aluminum, titanium or the like and to then perform the subsequent reactions as described above. The advantage of this route is the ability to generate in one simple approach (i.e., generally without a workup step)—starting from a single base resin (completely hydrolyzed/condensated) and by employing variable amounts of the reactants and/or their amount of functional groups—a variety of resins with different organic crosslinking potential and link length (→ after curing variable crosslink density), having different polarity, refractive index, etch and complexation properties.

The silicic acid polycondensates according to the invention can be cured in different ways. Thus, existing C═C double bonds can be subjected to crosslinking by means of a polyaddition with thiols or amines, or a conventional group polymerization of the double bond—containing groups (reaction to create carbon chain growth polymerization), which causes the material to cure. The condensates can also be cured by other crosslinking reactions, for example by reaction with di-, tri- or tetra-isocyanates, which attack free carboxylic acid or hydroxy groups, or with corresponding polyfunctional anhydrides for reacting hydroxy-containing condensates, which also results in the formation of another pure organic network.

During crosslinking, other properties, such as the length of the molecular chains between crosslinking sites and the remaining proportions of free reactive groups, can be tuned, for example, by the addition of variable proportions of di-, tri- and/or tetra-isocyanates that are able to react with free Q groups. The corresponding mono compounds would only lead to reaction of the reactive groups and thus to their conversion to an inactive coupling group. If, however, tris- or even higher polyfunctional compounds are employed as reaction partners, bonds with adjustably tunable lengths are generated by bridges (the length is adjusted by the distance between two reactive groups in the molecule). An example is shown by the reactions of isocyanates: Here, for example, the following compounds can be employed: dicyclohexylmethane diisocyanate, hexamethylene-1,6-diisocyanate, hexamethylene-1,8-diisocyanate, diphenylmethane-4,4-diisocyanate, diphenylmethane-2,4-diisocyanate, 2,4-tolylene diisocyanate, 2,6-tolylene diisocyanate, triphenylmethane-4,4′,4″-triisocyanate, 3-isocyanatomethyl-3,5,5-trimethylcyclohexyl diisocyanate, or tris(p-isocyanatophenyl)thiophosphate. Provided the silane or polysiloxane has free hydroxy groups (e.g. in the case of Q being at least partially=OH), such crosslinking may also be performed using a di-, tri-, tetra-or polyfunctional, optionally activated (e.g. in form of an anhydride) carboxylic acid in lieu of the di-, tri- or tetrapolyisocyanate, and provided the silane or polysiloxane comprises free carboxylic acid groups, salts or esters thereof, with a di-, tri-, tetra- or polyfunctional alcohol.

The curing of resins in which the Q group is R₁, i.e. an unsaturated organically polymerizable group such as a C═C-containing group, can be effected by additives. Examples include variable proportions of di-, tri, tetra-amines capable of reacting with reactive C═C double bonds, and thus, for example, with (meth)acrylate groups. Here, aside from crosslinking via light-induced organic polyaddition, crosslinking can be achieved via polyfunctional amines. Examples of polyfunctional amines are: diaminoaceton, diaminoacridine, diaminoadamantane, diaminoantraquinone, benzidine, diamino benzoic acid, phenylenediamine, diaminobenzo-phenone, diaminobutane, diaminocyclohexane, diaminodecane, diaminodicyclohexylmethane, diaminomethoxybiphenyl, diaminodimethylhexane, diaminodiphenyl methane, diamino-dodecane, diaminoheptane, diaminomesitylene, diaminomethylpentane, diaminomethylpropane, naphtyhlendiamine, diaminoneopentane, diaminooctane, diaminopentane, diaminophenantrene, diaminopropane, diaminopropanol, diaminopurine, diaminopyrimidine.

The same result can be obtained when thiols are employed rather than the aforementioned amines. Examples of polyfunctional thiols are: trimethylolpropane tri(3-mercapto propionate) (TMPMP); trimethylolpropane trimercaptoacetat) (TMPMA); pentaerytritoltetra (3-mercaptopropionate) (PETMP); pentaerytritoltetramercaptoacetate) (PETMA); glycol dimercaptoacetate; glycol di(3-mercapto-propionate); ethoxylated trimethylolpropane tri(3-mercaptopropionate); biphenyl-4,4′-dithiol; p-terphenyl-4,4″-dithiol; 4,4″-thiobisbezenthiol; 4,4″-dimercaptostilben; benzene-1,3-dithiol; benzene-1,2-dithiol; benzene-1,4-dithiol; 1,2-benzendimethanthiol; 1,3-benzendimethanthiol; 1,4-benzendimethanthiol; 2,2′-(ethylenedioxy)diethanthiol; 1,6-hexane dithiol; 1,8 octandi-thiol; 1,9 nonanedithiol.

The resin systems (i.e. the silicic acid polycondensates) of the present invention and/or their cured products can be used for a variety of applications, including in particular for dental purposes, preferably for direct/indirect restorations, prophylaxis (e.g. via fissure sealing), dental adhesives, prosthetics and dental replacements.

In the following, the invention will be explained in more detail by reference to specific reaction examples:

Curing of the resins is achieved by placing the resin together with 1 wt. % lucirin TPO in a rod-shaped form (2×2×25 mm³). The (meth)acrylate groups are reacted by a photo-induced group polymerization, causing the resin to harden. By means of 3-point bending test after 1.5 days of storage at 40° C. the modulus of elasticity, fracture strength and the deflection up to fracture of the resultant rods is determined. The shrinkage values are obtained by means of a buoyancy method in the context of the photo-induced group polymerization (15 min after exposure).

### COMPARATIVE EXAMPLE 1

### Synthesis of Base Resin System I

Hydrolysis/condensation of (methacryloxymethyl)-methyldimethoxysilane

61.3 g (0.30 mol) of (methacryloxymethyl)-methyldimethoxysilane are dissolved in ethyl acetate (1000 ml/mol silane) and following addition of H₂O for hydrolysis, stirred with HCl as catalyst at 30° C. The course of the hydrolysis is monitored by water titration. The work up is performed after approximately 2 days of stirring with repeated shaking with aqueous NaOH and then with water and filtration through a hydrophobic filter. The reaction is first spun off, and then drawn off under an oil pump vacuum. The result is a liquid resin without the use of reaction diluters (monomers) with a very low viscosity of about 38 mPa·s at 25° C. The resin is cured as described above.

Mechanical Data:
flexural strength=48 MPa; Modulus of elasticity=2.6 GPa
   Very low strength with high brittleness
Hardness Shrinkage: 7.1 vol.-% (15 min after exposure)
   High hardness shrinkage

Refractive index=1.465

### PREPARATION EXAMPLE 1a

### (Preparation of Grouping-AW(Z)ₐ in the Structure According to the First of the Examples Described Above, but with a 5% Deficiency of Thioglycerol (α=0.05)

To 7.92 g (0.05 mol) of base resin system I and optional 0.10 g of triethylamine 5.14 g 0.048 mole) of thioglycerol(3-mercaptopropane-1,2-diol) is added dropwise with stirring. The reaction can be monitored by NMR as well as by the decrease of the HS band by means of Raman spectroscopy. The band characteristic of the HS group appears in the Raman spectrum at 2568 cm^{-1.} The result is a liquid resin. A further work-up is not usually required.

### PREPARATION EXAMPLE 1b

### (Preparation of the Grouping-AW(Z)_{A} as in Preparation Example 1a, but with a 50% Deficiency of Thioglycerol (α=0.50)

To 19.0 g (0.12 mol) of base resin system I and optionally 0.12 of triethylamine, 6.49 g (0.06 mole) of thioglycerol (3-mercaptopropane-1,2-diol) is added dropwise with stirring. The result is a liquid resin having a viscosity of about 2.8 Pa·s at 25° C. (depending on the precise synthesis arid work up conditions of the precursor). A further work-up is not usually required.
The refractive index of this product is finely tuneable via the thiol portion (a slight increase compared to the basis resin system I is observed; with the thiol proportion used in this example, it increases to 1.482)
The polarity/hydrophilicity is adjustable via the OH content that is introduced via the thiol compound, such as in the present example via thioglycerol (i.e. strong, graded increase compared to the base resin system I)

### EXAMPLE 1a

### Preparation of a Polysiloxane of the Structure (3) with Q=Organically Polymerizable Group (Methacrylate) using the Product of the Preparation Example 1a

To 5.22 g of a reaction mixture of base resin system I and Example 1a (molar ratio=1:0.95), 2.79 g (0.0224 mol) isocyanatoethyl methacrylate was added dropwise at 30° C. under a dry atmosphere and stirred further at 30° C. The reaction can be monitored via the reduction of the OCN band by means of the IR spectrum. The band characteristic of the OCN group appears in the IR spectrum at 2272 cm^{-1.} The result is a liquid resin having a viscosity of approximately 2500 Pa·s at 25° C.

### EXAMPLE 1b

### Preparation of a Polysil(xane of the Structure (3) with=Organically Polymerizable Group (Methacrylate) using the Preparation Example 1b

To 19.2 g of a reaction mixture of base resin system I and Example 1b (molar ratio=1:0.50), 19.96 g (0.090 mol) of isocyanatoethyl methacrylate was added dropwise under a dry atmosphere at 30° C. with stirring and further stirred at 30° C. The result is a liquid resin having a viscosity of approximately 2700 Pa·s at 25° C. The resin is subsequently cured.
flexural strength=135 MPa; Modulus of elasticity=3.2 GPa
   Very high strength with significantly reduced brittleness (compared to the underlying base resin system I)
Hardness shrinkage (comparison): 5.8 vol.-% (15 min after exposure)
   Significantly reduced hardness shrinkage (compared to the underlying base resin system 1)

TABLE 1

| | Breaking | Modulus of | Shrinkage |
|---|---|---|---|
| Resin | strength | eleastivity | (15 min/1 day) |
| system | [MPa] | [GPa] | [vol.-%)] |
| Based resin system I | 48 | 2.60 | 7.1 |
| (comparison) | | | |
| Example 1b | 135 | 3.20 | 5.8 |

It can thus be seen from the example that by chain branching on a single material base, a generally very broad modulus range can be tuned and significantly improved mechanical data achieved (increased strength, reduced brittleness) compared to the underlying base resin (prior art). The systems can be implemented without the use of dental monomers, which is essential given the increasing allergy discussion in the dental field. The invention also provides for additional functionalization via the introduction of additional OH, or other groups. The product thus obtained has a low shrinkage value.

### COMPARATIVE EXAMPLE 2

### Synthesis of the Base Resin System II

To 41.2 g (0.2 mol) of [3-(2-trimethoxysilyl)propyl]methyldimethoxysilane and 50.6 g of triethylamine in 200 ml of anhydrous toluene, 43.9 g (0.42 mol) of methacryloyl chloride are added dropwise at a temperature of 5-10° C. and then stirred for about 18 h at 23° C. The precipitate is filtered off and the filtrate washed twice with 150 ml of water. After addition of 20.5 mg of BHT (4-hydroxy-3,5-di-tert.butyltoluol) the solvent is removed under reduced pressure and a viscous resin is obtained. A further work-up is not usually required. The resin dissolved in 200 ml ethyl acetate is hydrolyzed by addition of dilute hydrochloric acid at 30° C. The work up is performed after approximately 2 days of stirring with repeated shaking with aqueous NaOH and/or with water and filtration through a hydrophobic filter. After removal of the solvent under reduced pressure, a highly viscous resin is obtained.

### PREPARATION EXAMPLE 2

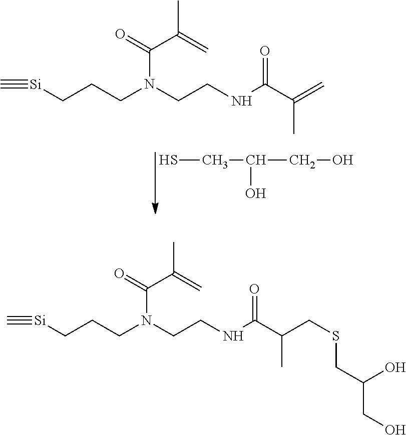

First, 14.8 g (0.05 mol) of base resin system II and 5.4 g (0.05 mole) of thioglycerol are dissolved in 20 ml of toluene at 85° C. After the addition of approximately 1 ml of 1,8-diazabicyclo[5,4,0]undec-7-ene as catalyst for the thiol addition, the reaction mixture is further heated with stirring for about 6 h. The reaction can be monitored by by the decrease of the C═C double bond via NMR spectroscopy. After removal of the solvent under reduced pressure, a highly viscous resin is obtained. A further work-up is not usually required. The ratio of methacrylic groups to thiol groups in this example is 2:1: therefore, the thiol-ene addition occurs mainly only on the secondary amino group-bound methacrylic group that is preferred for the reaction while the tertiary-bound methacrylic group is not converted.

### EXAMPLE 2

### Preparation of a Polysiloxane with Phosphoric Acid Functionalities

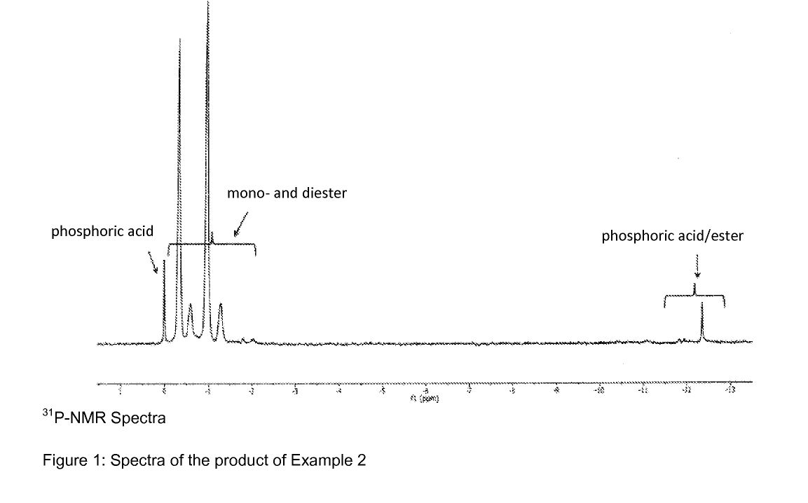

8.08 g (0.02 mol) of resin from Preparation Example 2 are suspended in 30 ml anhydrous methylene chloride and 14.2 g (0.1 mol) of P₂O₅ is added portionwise. The reaction mixture is stirred at 23° C. for about 18 h. Then, 50 ml of water are added and stirred at 23° C. for another 24 h. After removal of the solvent, a high-viscosity, water-soluble product is obtained. The ³¹P spectra (FIG. 1) demonstrates conversion with P₂O₅ with formation of the desired phosphoric acid alkyl ester.

### COMPARATIVE EXAMPLE 3

### Synthesis of the Base Resin System III

43.7 g (0.20 mol) of (acryloxypropyl)-methyldimethoxysilan are dissolved in 200 ml of ethyl acetate and, after addition of H₂O for hydrolysis stirred at 30° C. in the presence of HCl as catalyst. The course of the hydrolysis is monitored by water titration. The work up is performed after about 2 days of stirring by shaking with water and filtration through a hydrophobic filter. The reaction is first spun off, and then drawn off with under oil pump vacuum. The result is a liquid resin without the use of reactive diluents (monomers) with a very low viscosity of about 85 mPa·s at 25° C. The resin is cured as described above.

Mechanical Comparative Data:
flexural strength=37 MPa; Modulus of elasticity=1.3 GPa
   →Very low strength with high brittleness
cure shrinkage; 7.5 vol.-% (15 min after exposure)
   →High cure shrinkage

### PREPARATION EXAMPLE 3

To 19.0 g (0.11 mop of basic resin system III, 9.83 g of diethanolamine (0.0935 mol=85 mol %, relative to the number of acrylate groups of the base resin system, i.e., α=0.15) are added dropwise under stirring and stirred for about 1 day at room temperature. The reaction can be monitored, for example, by the decrease of the acrylate group via NMR. The result is a liquid resin without the use of reactive diluents (monomers) with a very low viscosity of about 12 Pa·s at 25° C. A further work-up is not usually required.

### EXAMPLE 3

### Preparation of a Polysiloxane of Structure (3) with Q=Organically Polymerizable Group (Methacrylate Grorup) from the Product of Preparation Example 3

To 18.3 g (0.07 mol) of resin from Preparation Example 3, 17.9 g methacrylate isocyanatoethyl (0.116 mol; 195 mol % relative to the diethanolamine group and/or 97 mol-%, relative to the hydroxy groups of the resin) is added dropwise under a dry atmosphere at 30° C. with stirring. The reaction can be monitored by the reduction of the OCN band via IR spectrum. The band characteristic of the OCN group appears at 2273 cm⁺¹ in the IR spectrum. The result is a liquid resin having a viscosity of about 97 Pa·s at 25° C. The resin is cured a described above.

Mechanical Data:
flexural strength=114 MPa; Modulus of elasticity=2.3 GPa
   Very high strength with significantly reduced brittleness compared to the underlying resin system II
   cure shrinkage: 4.8 vol.-% (15 min after exposure) Significantly reduced cure shrinkage compared to the underlying resin system III

### COMPARATIVE EXAMPLE 4

### Synthesis of the Base Resin System IV

141.4 g (0.60 mol) of (methacryloxypropyl)methyldimethoxysilane is dissolved in ethyl acetate (1000 ml/mol silane) and stirred, after the addition of H₂0 for hydrolysis, with HCl as a catalyst at 30° C. The course of the hydrolysis is followed in each case by water titration. The work up is performed after about 2 days of stirring with repeated shaking with water and filtration through a hydrophobic filter. The solvent is first removed by rotary evaporation and subsequently drawn off under oil pump vacuum. A liquid resin results without the use of reactive (monomers) with a very low viscosity of about 62 mPa·s at 25° C. A further work-up is usually not required (oil pump vacuum is optionally applied for drying). This resin is cured as described above.

Mechanical comparison data: bending strength, ≈67 MPa; E-Modulus≈1.63 GPa

→Low strength

Cure shrinkage (Comparison): 7.2 vol -% (15 minutes after exposure)

→High cure shrinkage

### PREPARATION EXAMPLE 4

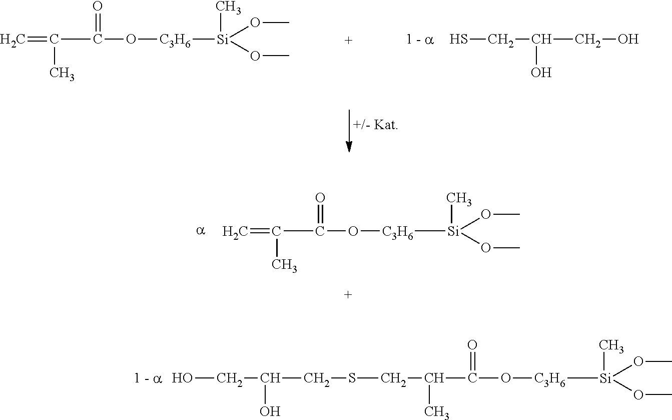

### PREPARATION EXAMPLE 4a

### α=0.5

To 45.5 g (0.24 mol) of basic resin system IV and optionally about 0.29 g of triethylamine, 13.0 g (0.12 moles) of thioglycerol (3-mercaptopropane-1,2-diol) is added dropwise under stirring.

The reaction can be monitored by NMR and by the decrease of the characteristic HS band (2568 cm⁻¹) by Raman spectroscopy. A liquid resin is formed. A further work-up is usually not required (optionally oil pump vacuum for drying).

### PREPARATION EXAMPLE 4b

### α=0.95

The synthesis is carried out analogously to the preparation of Example 4a, but with a content of about 0.23 mol thioglycerol, which also results in formation of a liquid resin. A further work-up is usually not required (optionally, oil pump vacuum is applied for drying).

### EXAMPLE 4.1

### Preparation of a Polysiloxane of the Structure (3) with Q=Organically Polymerizable Group (Methacryl Group) which is Bonded Via a Urethane Coupling Group.

Basic Reaction Principle:

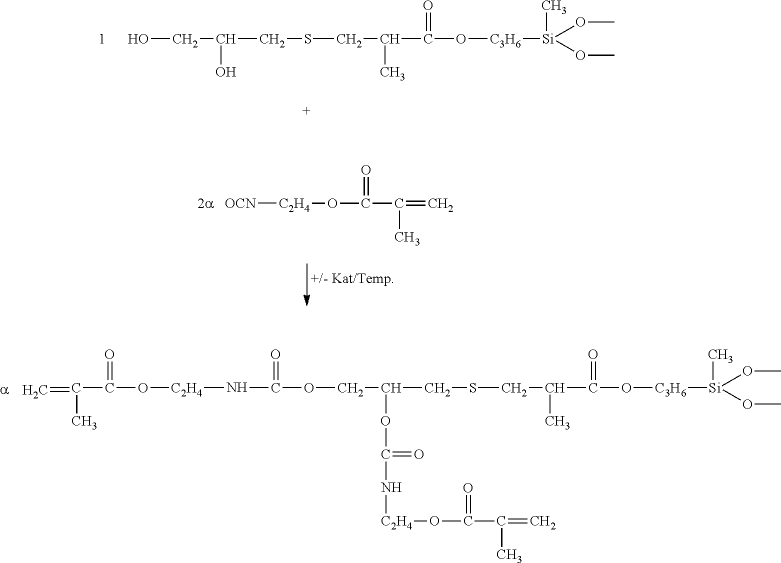

In this reaction, the molar fraction a of isocyanate may be ≦1.

### EXAMPLE 4.1

### α=0.95

To 38.6 g (0.158 mol) of resin from Preparation Example 4 (molar ratio of silicon atoms in the base resin system IV to thioglycerol=1: 0.5), 23.3 g (0.95 mol) of isocyanatoethyl methacrylate admixed with 0.06 g of BHT (2,6-di-tert-butyl-4-methylphenol) is added dropwise under dry atmosphere at 30° C. with stirring and further stirred at 30° C. (as the catalyst, for example DBTL=dibutyltindilaurate can be optionally added). The reaction can be monitored via the decrease of the characteristic band at 2272 cm-OCN⁻¹ in the IR spectrum. A liquid resin is formed with a viscosity of about 470 Pa-s at 25° C. A workup is usually not required. The resin is cured as described above.

Mechanical data: bending strength≈120 MPa; Modulus of elasticity≈2.5 GPa

→Very high strength and significantly increased E-Modulus compared to the underlying resin system IV

Cure shrinkage:≈5, 1 vol -% (15 min after exposure)

→Significantly reduced cure shrinkage compared to the underlying base resin system IV

### EXAMPLE 4.2

### Preparation of a Polysiloxane of the Structure (3) with Q=Organically Polymerizable Group (Methacryl Group) that is Bonded Via a Carboxylic Acid Ester Coupling Group

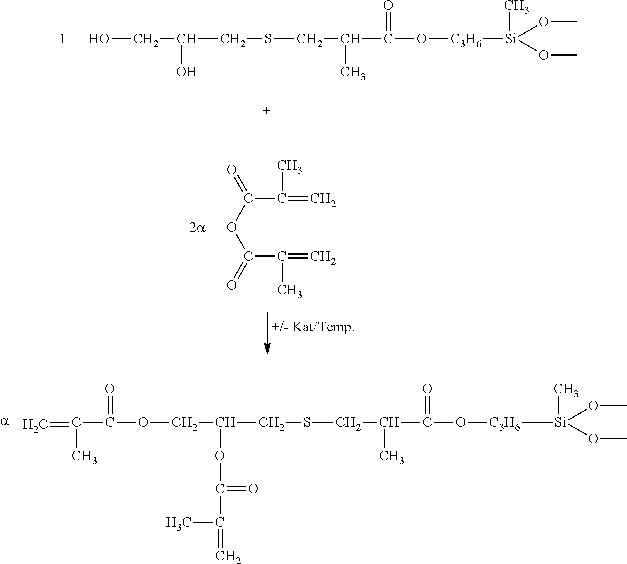

For this example, ratios were chosen that correspond to α=0.86 of above formula.

To 26.2 g (0.11 mol) resin from Example 4a (base resin system IV: thioglycerol 1:0.5) containing 0.025 g dissolved BHT (2,6-di-tert.butyl-4-methylphenol) and, as catalyst 0.11 g of DABCO (1,4-diazacicyclo[2.2.2]octane), 14.65 g (0.095 mol) of methacrylic anhydride was added dropwise with stirring in a dry atmosphere at ≈65° C. and further stirred under reflux at 30° C. The reaction can be monitored by NMR as well as by the decrease of the anhydride band (1785/1722 cm⁻¹) in the IR spectrum. Following customary work-up to separate methacrylic acid released in the addition reaction and removal of volatile components under oil pump vacuum, a liquid resin results having a viscosity of approximately 1.6 Pa·s at 25° C.

Mechanical data: bending strength, ≈84 MPa; Modulus of elasticity≈1.8 GPa

From the data increased strength and modulus of elasticity results compared to the underlying resin system IV.

What is claimed is:

1. Method for converting reactive groups of Si—C-bound groups of silanes or siloxanes while simultaneously increasing the physical distance between said groups, wherein the Si—C-bound groups have the grouping
-AW(Z)ₐ,
wherein
A represents a coupling group selected from —S—, —NH— and NR³, wherein R³ represents an unsubstituted or substituted hydrocarbon group or a (meth)acryl group,
W is a substituted or unsubstituted hydrocarbon group, the chain of which may be interrupted by one or more groups of —S—, —O—, —NH—, —NR³—, —C(O)O—, —NHC(O)—, —C(O)NH—, —NHC(O)O—, —C(O)NHC(O)—, —NHC(O)NH—, —S(O)—, —C(S)O—, —C(S)NH—, —NHC(S)—, —NHC(S)O—, R³ having the aforementioned meaning,
Z represents a functional group which may be the same or different and is selected from OH, the carboxylic acid group —COOH or a salt or an ester of said group, and
a=2, 3, 4, 5 or a greater integer,
characterized in that, in a single or second reaction, said groups of the silane or siloxane are either reacted with a compound (II)
Y—(W)ₖ-(Q)_{b} (II),
wherein Y is NCO, epoxy, or if the groups Z are hydroxy groups —COA′, wherein A′ represents hydroxy, a halide, or —OC(O)R⁴, in which R⁴ is an unsubstituted or substituted hydrocarbon group,
W has the aforementioned meaning,
Q is either R¹ or OH, NR⁷₂, NR⁷₃⁺, CO₂H, SO₃H, PO(OH)₂, (O)PO(OH)₂, (O)PO(OR⁴)₂ or a salt or an ester of the aforementioned acids, wherein R¹ is an unsaturated, organically polymerizable group and R⁴ has the aforementioned meaning, R⁷ has either the same meaning as R⁴, or two groups of R⁷ together can represent an optionally substituted, optionally unsaturated alkylene group,
k=0 or 1, where k=0 only in the event that Y represents CON, and
b=1, 2, 3, 4 or a greater integer,
or, in the event Z═OH the groups of the silanes or siloxanes are reacted with P₂O₅ or POCl₃.

2. Method according to claim 1, wherein the compound of formula (II) is used in an amount such that the molar ratio of this compound to the molar amount of the groups Z is <1:1 and preferably is at most 0.95.

3. Method according to claim 1, wherein in the compound of formula (II) Y is NCO.

4. Method according to claim 1, wherein in the compound of formula (II) b=1, and Q represents an unsaturated, organically polymerizable group, in particular a (meth)acrylic acid group.

5. Method for converting reactive groups on Si—C-bound groups of silanes or siloxanes according to claim 1, wherein the Si—C-bound groups having the grouping
AW(Z)ₐ
are obtained in a first reaction by conversion of Si—C bound groups carrying at most one unsaturated organically polymerizable group, with a compound of formula (I)
X—W—(Z)ₐ (I),
wherein
X is SH, NH₂ or NHR⁴.

6. Method according to claim 5, wherein in the compound (I) Z is —OH.

7. Method according to claim 6, wherein in the compound of formula (I), X is SH and a is 2, 3, or 4, and preferably 2.

8. Method according to claim 6, wherein in the compound of formula (I) X is NHR⁴ and a is 2, 3, or 4, and preferably 2.

9. Method according to claim 5, wherein the reaction with compound (II) is conducted without work-up of the product of the first reaction.

10. Method according to claim 1, wherein in the compound of formula (II) used in the one or second reaction, Q is R¹, comprising a third reaction with a compound of formula (III)
X—W(Q)_{b} (III)

11. Method according to claim 1, wherein in the compound of formula (II) used in the second reaction Q is selected from OH, the carboxylic acid group —COOH and a salt or an ester of said group, comprising a third reaction with a compound (II)
Y—W-(Q)_{b} (II)

12. Method according to claim 10, wherein the molar ratio of the compound (III) and/or of the compound (II) relative to the molar proportion of the groups Q is <1:1 and preferably at most 0.95.

13. Method according to claim 10, wherein in the compound of formula (III) and/or formula (II) used in the third reaction Q has the meaning R¹, comprising a fourth reaction with a compound of formula (III)
X—W-(Q)_{b} (III)

14. Method according to claim 10, wherein the compound of formula (III) and/or (II) in the third reaction Q is selected from OH, the carboxylic acid group —COOH and a salt or an ester of said group, comprising a fourth reaction with a compound (II)
Y—(W)ₖ-(Q)_{b} (II)

15. Method according to claim 1, further comprising
(a) reacting each method product with a di-, tri-, tetra- or polyfunctional thiol, or
(b) reacting each method product with a di-, tri-, tetra- or polyfunctional amine or
(c) polymerizing the respective method product in a polymerization reaction in which a part or all of the existing reactive double bonds are incorporated into an extending carbon chain under the influence of heat, light, ionizing radiation, or by redox reaction.

16. Method according to claim 1, wherein Q is selected from OH, the carboxylic acid group —COOH and a salt or an ester of said group, further comprising
(a) crosslinking at least a portion of the existing hydroxy or carboxylic acid groups with a di-, tri-, tetra- or polyfunctional isocyanate or
(b) provided Q=OH, cross-linking existing hydroxy groups with a di-, tri-, tetra-, or polyfunctional, optionally activated carboxylic acid or such anhydride,
(c) provided Q=COOH, cross-linking existing carboxyl groups with a di-, tri-, tetra-, or poly-functional alcohol.

17. Compound or silicic acid(hetero)polycondensate of formula (3), 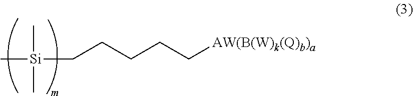
wherein
the three unspecified bonds of the silicon atom represent further silicon-bound groups selected from silicon hydrolyzable groups, hydroxy groups, groups bound to silicon via carbon atoms and oxygen bridges to other silicon atoms and/or other metal atoms,
the zigzag line of the backbone representing represents a hydrocarbon atom group bound to silicon via a carbon atom, wherein said backbone may be optionally branched, and may be arbitrarily interrupted by hetero atoms or coupling groups or other hetero atom-containing groups, wherein the hydrocarbon group, with the exception of the grouping AW(B(W)ₖ(Q)_{b})ₐ, does not contain functional groups,
A represents a coupling group selected from —S—, —NH—, and NHR³,
B represents a coupling group selected from ester, ether, acid amide and urethane groups,
W is a substituted or unsubstituted hydrocarbon group, the chain of which may be interrupted by one or more groups —S—, —O—, —NH—, —NR³—, —C(O)O—, —NHC(O)—, —C(O)NH—, —NHC(O)O—, —C(O)NHC(O)—, —NHC(O)NH—, —S(O)—, —C(S)O—, —C(S)NH, NHC(S)—, NHC(S)O—, wherein R³ represents an unsubstituted or substituted hydrocarbon group or a (meth) acrylic group,
Q is either R¹ or OH, NR⁷₂, NR⁷₃⁺, CO₂H, SO₃H, PO(OH)₂, PO(OR⁴)₂, (O)PO(OH)₂, (O)PO(OR⁴)₂ or a salt of the aforementioned acids, wherein R¹ represents an unsaturated, organically polymerizable group, and R⁴ is an unsubstituted or substituted hydrocarbon group, R⁷ has either the same meaning as R⁴, or two groups R⁷ may together represent an optionally substituted, optionally unsaturated alkylene group,
the subscript k being 0 or 1,
the index m being 1, 2 or a integer greater than 2,
a=2, 3, 4, 5 or a greater integer, and
b is 1, 2, 3, 4 or a greater integer.

18. Compound or silicic acid(hetero)polycondensate of formula (4) 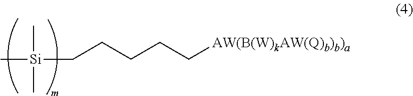
wherein D is selected from A′W(Q)_{b}, B(W)ₖ(Q)_{b}, A′W(AW(Q)_{b})_{b}, A′W(B(W)ₖ(Q)_{b}) _{b}, B(W)ₖ(AW(Q)_{b})_{b} and B(W)ₖB(W)ₖ(Q)_{b})_{b}, wherein Q, A, B, W, k, m, a and b have the meaning defined in claim 17 and A′ is a coupling group, generated by the attack of group X of a compound XW(Q)_{b}, wherein X is selected from SH, NH₂ and NHR³, R=unsubstituted or substituted hydrocarbon group, at the C═C double bond of an unsaturated organically polymerizable group R¹.

19. Organic polymer obtained from a compound or silicic acid(hetero)polycondensate according to claim 17, wherein either at least some of the groups Q are unsaturated, organically polymerizable groups, by
(a) reacting said compound and/or said silicic acid(hetero)polycondensate with a two or polyfunctional thiol or amine, or
(b) by polymerizing the compound or the silicic acid(hetero)polycondensate in a polyreaction, in which a part or all of the existing reactive double bonds are incorporated into a propagating carbon chain under the influence of heat, light, ionizing radiation, or by redox reaction,
or at least some of the groups Q=OH or COOH, by
(a) crosslinking of existing hydroxy or carboxylic acid groups with a di- or polyfunctional isocyanate or
(b) crosslinking existing hydroxy groups with a di- or polyfunctional, optionally activated carboxylic acid, or
(c) crosslinking of existing carboxylic acid groups with a di- or polyfunctional alcohol.

21. (canceled)
